(19) United States
(12) Patent Application Publication
(10) Pub. No.: US 2002/0005242 A1
(43) Pub. Date: Jan. 17, 2002

(54) Method and device for producing a DVD

(75) Inventors: Anthonius Martinus Lambertus Habraken, Oedenrode (NL); Marc Evers, Geldrop (NL); Bob Reuser, Eindhoven (NL)

Correspondence Address: YOUNG & THOMPSON, 745 SOUTH 23RD STREET 2ND FLOOR, ARLINGTON, VA, 22202

(73) Assignee: O.T.B. Group B.V.

(21) Appl. No.: 09/905,486

(22) Filed: Jul. 16, 2001

(30) Foreign Application Priority Data
Jul. 14, 2000 (NL) 1015719
Feb. 2, 2001 (NL) 1017267

(51) Int. Cl. B32B 31/16

(52) U.S. Cl. 156/74

(57) ABSTRACT

A device for gluing together two disc halves which are each provided with a central hole, to produce a disc, for example an optical data carrier, such as a DVD, comprises a rotatable carrier provided with a mandrel on which the disc halves can be accommodated, in such a manner that the mandrel fits through their central holes. Furthermore, there is a light radiation source which emits a light beam which can be displaced in the radial direction with respect to the mandrel.

The invention relates to the field of producing a disc from two disc halves. Discs of this type are generally optical data carriers with a high storage capacity, such as DVDs. In this case, both disc halves bear a series of helical minuscule pits or bumps which can be read by means of a laser beam.

The disc halves are attached to one another by gluing. The glue is arranged in the area between the two disc halves in the vicinity of their central hole and is then spread by centrifugal forces over the entire surface area between the disc halves.

In this way, it is possible to ensure a reliable and complete join between the disc halves. Moreover, the centrifugal force ensures that the relatively thick bead of glue which was initially applied in the vicinity of the central hole is spread out very uniformly.

The bead of glue spreads out along a front which expands in the radial direction towards the edges of the disc halves. In the process, the problem may arise that, on account of the speed and force at which the front is being thrown outwards, the glue which is located directly behind this front is carried along with it. As a result, the thickness of the layer of glue becomes too small to ensure good adhesion.

It is an object of the invention to provide a method for producing discs as described above which does not have this drawback. This object is achieved by means of a method for gluing together two disc halves to produce a disc, for example an optical data carrier, such as a DVD, comprising the steps of:

placing one disc half (5) on a rotary member (3, 4);

applying a quantity of glue (20) to the disc half (5) in a central region thereof;

placing the second disc half concentrically onto the first disc half (5), so as to enclose the glue (20);

rotating the rotary member (3, 4) with the two disc halves (5, 21) in such a manner that, under the influence of the centrifugal force which is generated, the glue (20) spreads along an expanding front between the two disc halves (5, 21);

stabilizing the glue which is immediately behind the glue front by means of light radiation;

curing the glue (20);

removing the glued-together disc halves (5, 21) from the rotary member (3, 4).

Since, in the method according to the invention, the glue which is located immediately behind the glue front is stabilized and brought into a gel-like state, it is no longer possible for it to be sucked along with the glue front. Consequently, the desired thickness of the layer of glue is maintained over the entire surface of the disc halves. Usually, both disc halves have a central hole through which a mandrel provided on the rotary member can extend. The space between the two disc halves at the location of the central hole can be sealed by expanding the mandrel. Consequently, the glue cannot leak out into the hole, not even if the disc halves are pressed onto one another slightly. Consequently, the mandrel cannot become soiled.

It is preferable to use a mandrel with a relatively hard core and a flexible sleeve which surrounds the core, which sleeve can be expanded by means of compressed air.

In this case, the procedure can be as follows:

the first disc half is put in place;

the mandrel is then expanded;

glue is then applied to the first disc half;

the second disc half is then placed over the expanded mandrel, taking with it any glue adhering to the mandrel.

The glue is, as it were, scraped off the flexible sleeve by the second disc half, so that the sleeve does not become soiled even after large numbers of discs have been produced.

The invention also relates to a device for gluing together two disc halves which are each provided with a central hole, to produce a disc, for example an optical data carrier such as a DVD. According to the invention, this device has a radiation source which emits a light beam which can be displaced in the radial direction with respect to the mandrel.

The expandable mandrel can be designed in various ways. The mandrel preferably comprises a central core and a flexible sleeve which is connected in an airtight manner to the core, which core has an air-supply duct which opens out into the interior of the flexible sleeve.

The invention will now be explained in more detail with reference to an exemplary embodiment illustrated in the figures.

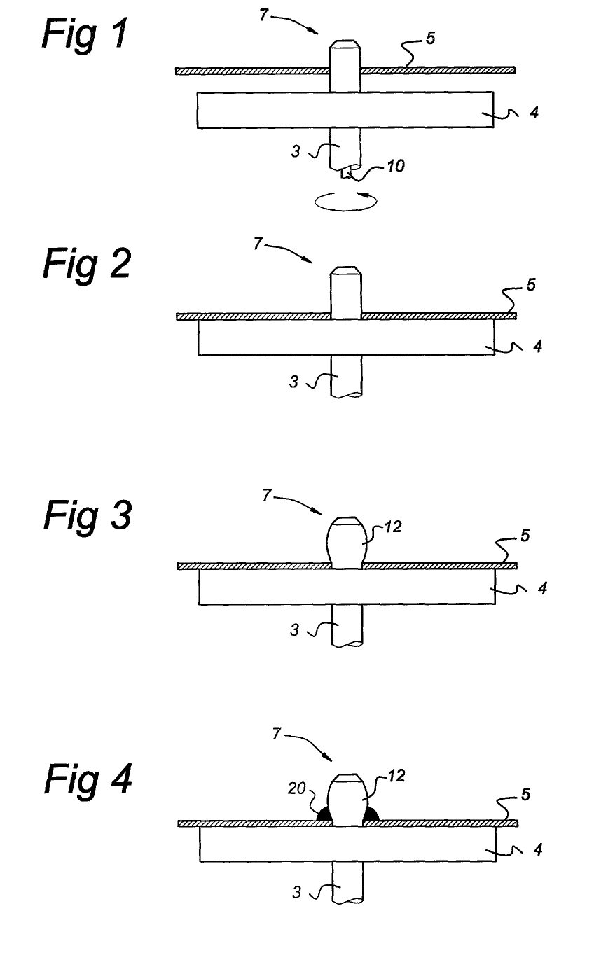

FIGS. 1-7 show the steps of the method according to the invention.

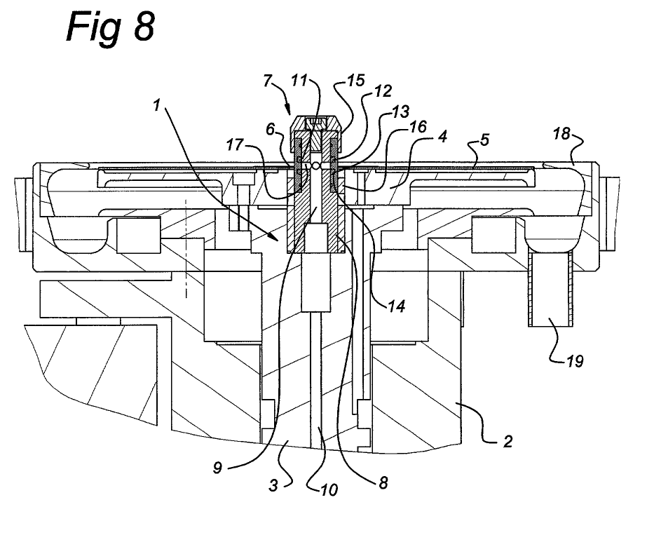

FIG. 8 shows a cross section through the device according to the invention.

The device for carrying out the method which is shown in FIG. 8 comprises a rotary member which is denoted overall by 1 and is mounted rotatably in a housing 2. The rotary member 1 comprises a spindle 3 which can rotate in the said housing 2 and a carrier 4 on which a first disc half 5 is arranged. This disc half 5 has a central hole 6 through which the mandrel, which is denoted overall by 7, fits. This mandrel 7 is attached to the spindle 3 and comprises a relatively hard core 8 with a bore 9 which is connected to the feed bore 10 in the spindle 3.

The core 8 has a constricted section 11 in which a flexible sleeve 12, for example made from rubber, is accommodated in a tight-fitting manner. This flexible sleeve 12 has recesses 13 which engage in ridges 14 of the core 8.

At the top, the flexible sleeve 12 is mounted within an attachment ring 15 and at the underside is mounted within an attachment ring 16.

Four radial ducts 17 run from the duct 9 in the core 8 towards the inner surface of the flexible sleeve 12. If compressed air is fed into the spindle 3 via the feed duct 10, the flexible member 12 expands as a result, in such a manner that it comes to bear firmly against the inner wall of the hole 6, which will be explained in more detail with reference to FIGS. 1-8.

At the outer circumference of the carrier 4 there is a collection rim 18 which is fixed to the housing 2. This collection rim collects any glue which is flung outwards during rotation of the disc halves 5 and discharges it via the outlet 19.

In the method according to the invention, the procedure is as shown diagrammatically in FIGS. 1-7, which in each case show the spindle 3, the carrier 4 and the mandrel 7. The other parts of the device according to the invention have been omitted for the sake of clarity.

As shown in FIG. 1, first of all a first disc half 5 is placed over the mandrel 7 onto carrier 4. The mandrel 7 has not yet been expanded.

In doing so, the state shown in FIG. 2 is reached, in which the first disc half 5 rests on the carrier 4. As shown in FIG. 3, the sleeve 12 is expanded so that it comes to bear firmly against the inner wall of the hole 6 in the first disc half 5. Then, as shown in FIG. 4, a bead of glue 20 is applied around the expanded sleeve 12, in the region of the first disc half 5 which adjoins the central hole in this disc half.

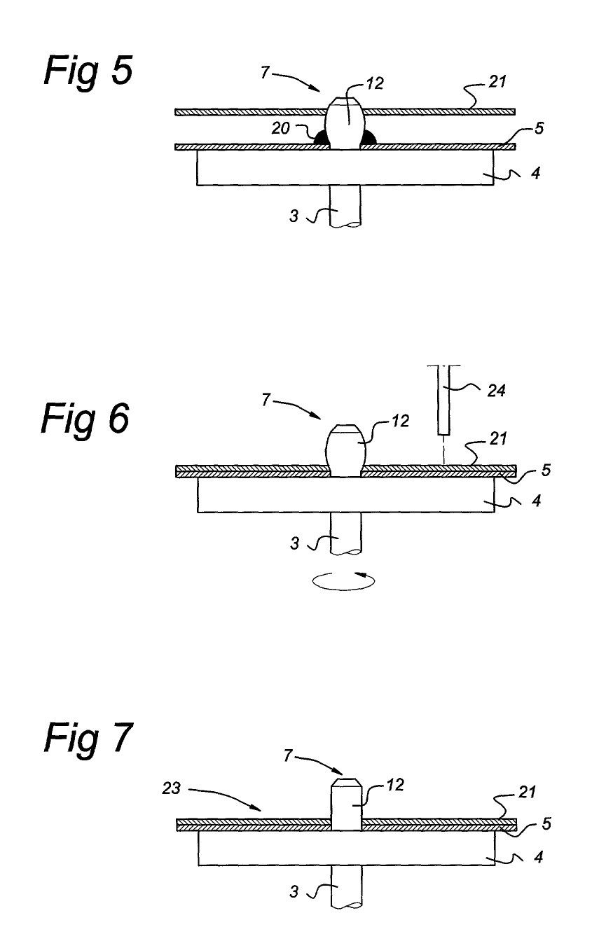

Then, as shown in FIG. 5, the second disc half 21 is placed onto the expanded sleeve 12, during which process the glue 20 adhering to the expanded sleeve 12 is scraped down towards the first disc half 5.

The disc halves 5, 21 which have been arranged on top of one another are rotated, in such a manner that the glue is spread, as a result of the centrifugal force which is thereby generated, over the whole of the mutually facing surfaces of the disc halves 5, 21. Under the influence of the centrifugal forces which are produced by rotation of the disc halves 5, 21, the layer of glue spreads outwards as an expanding front. This may cause the problem of the layer of glue immediately behind the said front becoming too thin on account of the glue being sucked along by the front.

In order to maintain the desired thickness of the layer of glue, according to the invention the glue immediately behind the front is stabilized by means of a source 24 which emits a beam of ultraviolet light. As a result, a gel-like character is imparted to the glue, thus preventing it from being sucked along by the front.

Finally, as shown in FIG. 8, the sleeve is depressurized, so that it returns to its original form, and the disc 23 which has been produced, comprising the disc halves 5, 21 which have now been glued together, can be removed from the carrier 4.

1. Method for gluing together two disc halves (5, 21) to produce a disc (23), for example an optical data carrier, such as a DVD, comprising the steps of:
placing one disc half (5) on a rotary member (3, 4);
applying a quantity of glue (20) to the disc half (5) in a central region thereof;
placing the second disc half concentrically onto the first disc half (5), so as to enclose the glue (20);
rotating the rotary member (3, 4) with the two disc halves (5, 21) in such a manner that, under the influence of the centrifugal force which is generated, the glue (20) spreads along an expanding front between the two disc halves (5, 21);
stabilizing the glue which is immediately behind the glue front by means of light radiation;
curing the glue (20);
removing the glued-together disc halves (5, 21) from the rotary member (3, 4) and the mandrel (6).

2. Method according to claim 1, comprising the step of stabilizing the glue behind the glue front by means of UV light radiation.

3. Method according to claim 1 or 2, for gluing together two disc halves (5, 21) which are each provided with a central hole (6), comprising the steps of:
placing one disc half (5) on a rotary member (3, 4) provided with a mandrel (7) in such a manner that the mandrel (7) fits through the central hole (6) in the said disc half (5);
expanding the mandrel (6) in such a manner that it comes to bear flush against the wall of the central hole (5) of the disc half which was put in place first;
then applying the quantity of glue (20) to the said disc half (5);
placing the second disc half concentrically onto the first disc half (5) over the mandrel (6), so as to enclose the glue (20);
rotating the rotary member (3, 4) with the two disc halves (5, 21) in such a manner that, under the influence of the centrifugal force which is generated, the glue (20) spreads along an expanding front between the two disc halves (5, 21);
stabilizing the glue which is immediately behind the glue front by means of light radiation;
curing the glue (20);
removing the glued-together disc halves (5, 21) from the rotary member (3, 4) and the mandrel (6).

4. Method according to claim 1, 2 or 3, comprising the step of providing a mandrel (6) which has a relatively hard core (8) and a flexible sleeve which surrounds the core (18), and expanding the sleeve (12) by means of compressed air.

5. Method according to one of the preceding claims, comprising the steps of:
putting the first disc half (5) in place;
then expanding the mandrel (6);
then applying glue (20) to the first disc half (5);
then placing the second disc half (21) over the expanded mandrel (6), taking with it any glue (20) adhering thereto.

6. Device for gluing together two disc halves (5, 21) to produce a disc (23), for example an optical data carrier such as a DVD, using the method according to one of claims 1-5, comprising a rotatable carrier (3, 4) on which the disc halves (5, 21) can be accommodated, characterized in that a light radiation source is provided which emits a light beam for curing the glue.

7. Device according to claim 6, wherein the light beam can be displaced in the radial direction with respect to the mandrel.

8. Device according to claim 6 or 7 for gluing together two disc halves (5, 21) which are each provided with a central hole (6), in which the carrier (3, 4) is provided with a mandrel (6) which can be fitted through the central holes (5) in the disc halves, the mandrel (6) being expandable in the radial direction.

9. Device according to claim 7 or 8, in which the mandrel (6) comprises a central core (8) and a flexible sleeve (12) which is connected to the core (8) in an airtight manner, which core (8) has an air-supply duct (9, 10) which opens out into the interior of the flexible sleeve (12).

10. Device according to claim 7, in which the mandrel (6) comprises a cylindrical core (8) provided with a central air-supply duct (9) to which at least one radial transverse duct (10), which opens out on the outer surface of the core (8), is connected.

11. Device according to claim 10, in which the core (8) comprises a constricted region (11) in which the sleeve (12) is accommodated.

12. Device according to claim 11, in which the sleeve is clamped in at both ends between a clamping ring (15, 16).

13. Device according to one of claims 6-12, in which the sleeve (12) has at least one internal recess (13), and the mandrel (6) has at least one corresponding ridge (14) which engages in the recess (13).
